(19) United States
(12) Patent Application Publication
(10) Pub. No.: US 2026/0188789 A1
(43) Pub. Date: Jul. 2, 2026

(54) THERMAL RUNAWAY PROTECTION MATERIAL CAPABLE OF RAPIDLY ABSORBING HEAT AND PREPARATION METHOD FOR THERMAL RUNAWAY PROTECTION MATERIAL

(71) Applicant: YANGTZE OPTICAL THERMAL-CONTROL TECHNOLOGY CO., LTD., Wuhan, Hubei (CN)

(72) Inventors: Xing HUANG, Wuhan, Hubei (CN); Zhengguo ZHANG, Wuhan, Hubei (CN); Xiaomeng YU, Wuhan, Hubei (CN); Junwan LIU, Wuhan, Hubei (CN); Liyun CUI, Wuhan, Hubei (CN); Ziye LING, Wuhan, Hubei (CN); Luxian ZHANG, Wuhan, Hubei (CN); Huan WAN, Wuhan, Hubei (CN); Yabin PI, Wuhan, Hubei (CN)

(73) Assignee: YANGTZE OPTICAL THERMAL-CONTROL TECHNOLOGY CO., LTD., Wuhan, Hubei (CN)

(21) Appl. No.: 18/858,701

(22) PCT Filed: Jun. 27, 2024
(86) PCT No.: PCT/CN2024/101971

§ 371 Date: Oct. 21, 2024

(30) Foreign Application Priority Data
Apr. 28, 2023 (CN) 202310479415.0

(51) Int. Cl. H01M 10/659; B32B 7/027; B32B 7/12; B32B 9/04; C09J 5/02; C09J 7/38; C09J 9/00; C09J 11/04; C09K 5/14; C09K 5/16; H01M 10/653

(52) U.S. Cl. CPC H01M 10/659; B32B 7/027; B32B 7/12; B32B 9/04; C09J 5/02; C09J 7/38; C09J 9/00; C09J 11/04; C09K 5/14; C09K 5/16; H01M 10/653; B32B 2307/302; B32B 2307/3065; B32B 2307/7376; B32B 2457/10; C09J 2301/408; C09J 2400/126

(57) ABSTRACT

A thermal runaway protection material capable of rapidly absorbing heat is provided. The material is of a laminated structure and sequentially includes a flame-retardant graphite heat-conducting film, heat-conducting glue, a high-heat-conductivity heat-absorbing material, heat-conducting glue and a flame-retardant graphite heat-conducting film from bottom to top. Peripheral side surfaces of the laminated structure are packaged by means of edge sealing glue. A preparation method for the thermal runaway protection material includes the following steps: brushing an upper surface and a lower surface of the high-heat-conductivity heat-absorbing material with the heat-conducting glue, then covering the heat-conducting glue on the two surfaces with the flame-retardant graphite heat-conducting films, performing flattening by means of a mold, after curing at a room temperature, cutting the high-heat-conductivity heat-absorbing material into a specified size, then brushing side surfaces with the edge sealing glue, and obtaining the thermal runaway protection material after drying.

### FIELD

The present disclosure belongs to the technical field of thermal runaway protection materials, and particularly relates to a thermal runaway protection material capable of rapidly absorbing heat and a preparation method for the thermal runaway protection material.

### BACKGROUND

With the rapid development of new energy vehicles and automatic driving techniques, there are more and more requirements for electronic control functions of the vehicles, and more and more electronic parts are needed. However, spaces of the vehicles are limited, so that reduction of sizes of the electronic parts and increase of sizes and energy densities of batteries are key research directions at present.

However, the risks of thermal runaways are also caused by packaging of a large number of electronic parts or high-energy batteries under the condition of very small sizes. The thermal runaways refer to chain reaction phenomena caused by various inducements, result in a large amount of heat and harmful gases emitted by apparatuses (such as chips, circuit boards and batteries) in a short time, and even cause fires and explosions in serious situations. These firing or explosion processes may cause thermal runaway diffusion on energy conduction (including heat, electric energy and mechanical energy) of other cells around and fires of sprayed objects. Thus, how to effectively control the thermal runaways is a very important research direction.

Three characteristic temperature points of the thermal runaways include a self-heating starting temperature T1, a thermal runaway initiation temperature T2, and a maximum thermal runaway temperature T3. Thus, if the heat inside the battery or part can be absorbed by means of a heat-absorbing material in a self-heating stage, the temperature can be prevented from rising to the thermal runaway initiation temperature T2, or the maximum thermal runaway temperature T3 can be reduced, thereby preventing further development of the thermal runaway. The heat-absorbing material is a material prepared by means of the characteristic that the material needs to absorb heat in a chemical or physical change process in phase change, dissolution and decomposition processes. By attaching the high-heat-conductivity heat-absorbing material to a heating electronic apparatus or battery for thermal control and rapid absorption of the heat released by the battery or electronic apparatus, the thermal runaway can be effectively relieved. Thus, the core is the selection of heat-absorbing materials and how to achieve high heat conductivity and package the heat-absorbing materials.

The batteries are taken as an example, and existing solutions for handling the thermal runaways are mainly as follows: (1) each battery group part is separated by means of aerogel, after the thermal runaway of a single battery group, the heat can be isolated within a limited range in less serious situations, but the aerogel cannot slow the progress of the thermal runaway, and after the thermal runaway occurs, there is also a possibility of overflowing to an adjacent battery group, resulting in fires or explosions caused by continuous thermal runaway; (2) thermal management is performed on the batteries by means of phase-change materials, and generally, the phase change enthalpy of the phase-change materials is only 200-270 J/g and is usually 100-200 J/g after packaging; due to the excessively low enthalpy, the phase-change materials are usually used to maintain a constant operating temperature (such as 55 DEG C.) for the batteries to enable the batteries to achieve the maximum effectiveness, and cannot solve the problem of thermal runaways; and (3) a liquid cooling system is mounted on the batteries, a compressor is used for refrigeration to cool the batteries, and due to the power limitation of the vehicle-mounted compressor, the cooling efficiency of the liquid cooling system is limited, and said system cannot handle the instantaneous temperature rise. The above solutions for handling the thermal runaways can achieve very limited effects under the condition of rapid temperature rises of the batteries due to extrusions, collisions and accidents.

The heat-absorbing materials that can have chemical changes at the temperature of 60-400 DEG C. to absorb a large amount of heat are mainly inorganic substances and usually exist in the form of powder. The powder contains a large amount of air, so that the heat conductivity coefficient is low, the heat absorption efficiency is low, the powder cannot be directly applied to heat absorption. In addition, the problems of size and shape changes caused by volatilization of crystal water and absorption of water under high humidity may occur during long-time exposure in the air, and thus the powder cannot be directly used.

### SUMMARY

In order to solve the above technical problems, the present disclosure provides a thermal runaway protection material capable of rapidly absorbing heat. The thermal runaway protection material has high strength and high vibration resistance, has a heat conductivity coefficient greater than 1 W/m·K, has a high heat absorption speed, and can be subjected to a chemical reaction at the temperature of 60-400 DEG C. and absorb heat actively, heat absorption by means of the reaction is carried out spontaneously after conditions of the chemical reaction are reached, the effect of continuous heat absorption is achieved (the heat absorption enthalpy of an internal high-heat-conductivity heat-absorbing material being greater than 1200 J/g), and the sufficient thermal runaway protection materials can reduce the maximum thermal runaway temperature and prevent fires and explosions caused by the high temperature.

In order to achieve the above purpose, the following technical solution is adopted for the present disclosure:
a thermal runaway protection material capable of rapidly absorbing heat, which is of a laminated structure and sequentially comprises a flame-retardant graphite heat-conducting film, heat-conducting glue, a high-heat-conductivity heat-absorbing material, heat-conducting glue and a flame-retardant graphite heat-conducting film from bottom to top. Peripheral side surfaces of the laminated structure are packaged by means of edge sealing glue.

According to the above solution, the thickness of the heat-conducting glue is in a range of 0.02-0.25 mm; the thickness of the flame-retardant graphite heat-conducting films is in a range of 0.02-0.5 mm; and the thickness of the high-heat-conductivity heat-absorbing material is determined according to actual situations, and is preferably in a range of 0.5-100 mm.

According to the above solution, the high-heat-conductivity heat-absorbing material comprises the following components in percentage by mass: 80-94% of a heat-absorbing material, 1-10% of a heat-conducting material, 0-1% of a flame-retardant graphite-loaded organic tin catalyst and 5-10% of bonding glue. A preparation method for the high-heat-conductivity heat-absorbing material comprises the following steps:
S1: adding the bonding glue, the flame-retardant graphite-loaded organic tin catalyst and the heat-conducting material into a mixing kettle, heating same to 30-60 DEG C., and stirring same for 2-4 h;
S2: slowly adding the heat-absorbing material into the mixing kettle, performing stirring while adding, performing vacuumizing to remove bubbles, and obtaining mixed glue;
S3: pouring the mixed glue into a polytetrafluoroethylene mold in a specified shape and thickness or a mold with a polytetrafluoroethylene coating on a surface, and curing same at a room temperature for 0.5-48 h; and
S4: performing demolding after curing time, and polishing edges to obtain the high-heat-conductivity heat-absorbing material.

In the above technical solution, the heat-absorbing material comprises but is not limited to one of or a mixture of a plurality of the following components in any ratio: sodium acetate trihydrate, ammonium iron oxalate trihydrate, citric acid monohydrate, citric acid, oxalic acid dihydrate, anhydrous oxalic acid, malonic acid, magnesium sulfate heptahydrate, zinc sulfate heptahydrate, succinic acid, maleic acid, fumaric acid, sodium carbonate decahydrate, calcium chloride hexahydrate, aluminum nitrate nonahydrate, ammonium pentaborate octahydrate, ammonium iron sulfate dodecahydrate, ferrous chloride tetrahydrate, ammonium oxalate monohydrate, sodium tetraborate decahydrate, sodium tetraborate pentahydrate, aluminum sulfate octadecahydrate, ammonium pentaborate, ammonium tetraborate tetrahydrate, sodium silicate pentahydrate, sodium aluminosilicate hydrate, potassium aluminum sulfate dodecahydrate, sodium sulfate decahydrate, copper sulfate heptahydrate, ferrous sulfate heptahydrate, cobalt chloride hexahydrate and calcium sulfate dihydrate. Preferably, the heat-absorbing material comprises but is not limited to one of or a mixture of a plurality of the following components in any ratio: oxalic acid dihydrate, anhydrous oxalic acid, ammonium oxalate monohydrate, barium hydroxide octahydrate, sodium acetate trihydrate, boric acid, ammonium pentaborate octahydrate, sodium tetraborate decahydrate, potassium aluminum sulfate dodecahydrate, sodium sulfate decahydrate and calcium sulfate dihydrate, and the mixture is preferably in 100-500 meshes.

In the above technical solution, the heat-conducting material is one of or a mixture of the following carbon-based heat-conducting materials in any ratio: carbon nano tubes, flame-retardant graphite, expanded graphite and graphene.

In the above technical solution, a preparation method for the flame-retardant graphite-loaded organic tin catalyst comprises the following steps: adding flame-retardant graphite and dibutyl tin diacetate in a mass ratio of 1:1 to 2:1 into a reactor, adding cyclohexane accounting for 30-100% of the total mass of flame-retardant graphite and dibutyl tin diacetate, maintaining the temperature at 50 DEG C., performing stirring for 2-3 h, placing same in a constant-temperature drying box at the temperature of 80-90 DEG C. for drying for 24 h, and obtaining the flame-retardant graphite-loaded organic tin catalyst. Flame-retardant graphite is preferably flake graphite. Flame-retardant graphite also has a very good heat conduction effect, and the heat conduction capacity of the material can also be improved by adding the flame-retardant graphite-loaded organic tin catalyst.

In the above technical solution, the bonding glue is low-viscosity bonding glue, is in a viscosity range of 5-200 mPa·S (25° C.), and is preferably LPA type low-viscosity perfusion glue produced by Yangtze Optical Electronic Co., Ltd. The bonding glue has low viscosity, small density and high infiltration capacity, contains a special wetting dispersant, and has excellent wettability for a surface of the heat-absorbing material, high-solid-content filling of the heat-absorbing material can be achieved by means of the bonding glue accounting for only 5-10% of the total mass, the operation time is long, and the curing time can be adjusted according to the addition amount of the flame-retardant graphite-loaded organic tin catalyst, thereby meeting different application requirements.

In the above technical solution, the heat absorption principle of the high-heat-conductivity heat-absorbing material is as follows: the heat-absorbing material is subjected to a chemical reaction at a high temperature, for example, the heat-absorbing material is decomposed to generate substances such as moisture and carbon dioxide, and a large amount of heat is actively absorbed in this chemical reaction process. The generated carbon dioxide can isolate combustibles from making contact with the air, and has an effect of preventing fires.

In the above technical solution, the heat-conducting glue is preferably SE4450 type two-component heat-conducting glue produced by Dow Chemical, has the heat conductivity coefficient greater than 1 W/m·K, and has the thickness in the range of 0.02-0.2 mm.

In the above technical solution, each flame-retardant graphite heat-conducting film has the thickness in the range of 0.02-0.5 mm and is a heat-conducting film prepared by compounding flame-retardant graphite with plastic particles, the heat conductivity coefficient of the plastic particles is greater than 1 W/m·K, the flame-retardant level reaches UL94-V0, and suitable plastics comprise but are not limited to one or more of polyamide, polyvinyl chloride, polycarbonate, polyphenylene sulfide, polyether ether ketone, poly (butylene succinate), polyethylene glycol terephthalate and polypropylene.

In the above technical solution, the edge sealing glue is preferably CM102 type curing glue produced by Yangtze Optical Electronic Co., Ltd., which has a very high bonding force and good edge sealing effect on the high-heat-conductivity heat-absorbing material, the heat-conducting glue and the flame-retardant graphite heat-conducting films.

In the above technical solution, a preparation method for the thermal runaway protection material capable of rapidly absorbing heat comprises the following steps: brushing each of an upper surface and a lower surface of the high-heat-conductivity heat-absorbing material with a layer of heat-conducting glue, then covering surfaces of the heat-conducting glue with the flame-retardant graphite heat-conducting films, performing flattening by means of a mold, placing same at the room temperature for 0.5-48 h, cutting same into a specified size, then brushing side surfaces with the edge sealing glue, and obtaining the thermal runaway protection material after placing at the room temperature for 1-48 h. The preparation method for the thermal runaway protection material capable of rapidly absorbing heat is actually a packaging method for achieving high heat conductivity and modularization of the heat-absorbing material, firstly, the powder heat-absorbing material, the heat-conducting material and the flame-retardant graphite-loaded organic tin catalyst are compounded and preliminarily packaged by means of the bonding glue, and then further laminated packaging and edge sealing are performed in combination with the heat-conducting glue and the flame-retardant graphite heat-conducting films, thereby achieving the high heat conductivity and packaging effect of the heat-absorbing material in the present disclosure, producing a thermal runaway protection block or sheet capable of rapidly absorbing heat, and controlling the size as required to achieve modular mounting.

Compared with the prior art, the present disclosure has the beneficial effects as follows:
1. by means of the high heat conductivity coefficient of the entire thermal runaway protection material in the present disclosure, the heat absorption process is rapid and effective, and the size can also be cut according to the requirements of a customer, so as to achieve modular mounting;
2. most of the heat-absorbing materials is low-heat-conductivity powder, the problems of size and shape changes caused by volatilization of crystal water and absorption of water under high humidity may occur during long-time exposure in the air, and thus the powder cannot be directly used. According to the thermal runaway protection material capable of rapidly absorbing heat, firstly, the high-absorption-enthalpy heat-absorbing material, the heat-conducting material and the flame-retardant graphite-loaded organic tin catalyst of the powder are compounded by means of the bonding glue, and the bonding glue replaces the air on the surface of the powder, so that stable packaging of the heat-absorbing material is achieved, and the problems of water absorption and water volatilization in case of exposure to the air are avoided; and then modular packaging is further achieved in combination with the heat-conducting glue and the flame-retardant graphite heat-conducting films, and the size is controlled as required, thereby obtaining the thermal runaway protection material capable of rapidly absorbing heat and capable of achieving modular mounting of the heat-absorbing material; and
3. the thermal runaway protection material in the present disclosure has a very high heat absorption enthalpy, and can be subjected to the chemical reaction at the temperature of 60-400 DEG C. and absorb heat actively, heat absorption by means of the reaction is carried out spontaneously after chemical conditions are reached, the effect of continuous heat absorption is achieved (the heat absorption enthalpy of the internal high-heat-conductivity heat-absorbing material being greater than 1200 J/g), and the sufficient thermal runaway protection materials can reduce the maximum thermal runaway temperature, control heating below the thermal runaway initiation temperature T2, and prevent fires and explosions caused by later continuous temperature rises.

### BRIEF DESCRIPTION OF THE DRAWINGS

FIG. 1 is a structural schematic diagram of a thermal runaway protection material capable of rapidly absorbing heat, which is composed of four parts, including 1—high-heat-conductivity heat-absorbing material, 2—heat-conducting glue, 3—flame-retardant graphite heat-conducting film, and 4—edge sealing glue.

FIG. 2 is a schematic diagram of a test platform for testing a thermal runaway effect of the thermal runaway protection material.

### DETAILED DESCRIPTION

In order to better understand the present disclosure, the present disclosure is further described below by means of particular embodiments, which do not serve as limitations on the present disclosure.

Some of special raw materials used in the following embodiments are as shown in Table 1.

TABLE 1

| S/N | Name | Description |
|---|---|---|
| 1 | Silicic acid | 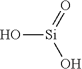 |
| 2 | Potassium aluminum sulfate dodecahydrate | 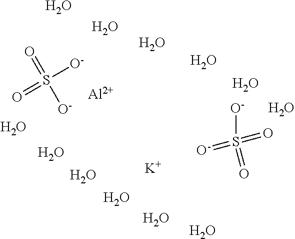 |
| 3 | Calcium chloride hexahydrate | 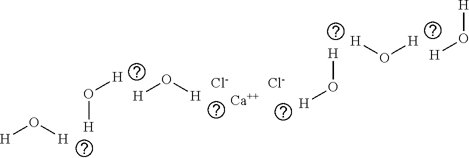 |
| 4 | Sodium acetate trihydrate | 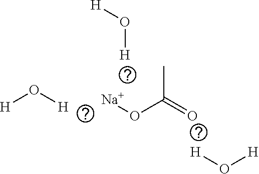 |
| 5 | Flame-retardant | Flake graphite, and Aladdin reagent |
| | graphite | |
| 6 | Dibutyl tin diacetate | 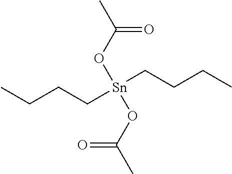 [SMILES: CCC[CH2][Sn]([CH2]CCC)([O]C(C)=O)[O]C(C)=O] |
| 7 | Flame-retardant | Using a heat-conducting film prepared from a |
| | graphite | nylon/flame-retardant graphite composite material and having |
| | heat-conducting | a thickness of 0.2 mm, a heat conductivity coefficient being 4 |
| | film | W/m · K, produced by Dongguan Qifu Plastic Raw Material |
| | | Co., Ltd. |
| 8 | Carbon nanotube | Industrial-grade multi-walled carbon nanotube with an outer |
| | | diameter being 10-20 nm and a length being 20-100 μm, and |
| | | Aladdin reagent |
| 9 | Edge sealing glue | CM102 two-component epoxy glue, produced by Yangtze |
| | | Optical Electronic Co., Ltd. |
| 10 | Bonding glue | LPA perfusion glue, produced by Yangtze Optical Electronic |
| | | Co., Ltd. |
| 11 | SE4450 | Dow Chemical |
| | heat-conducting | |
| | silica gel | |

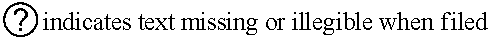

Meshes of the following involved heat-absorbing materials are in a range of 100-500 meshes.

Specific preparation methods for a flame-retardant graphite-loaded organic tin catalyst and high-heat-conductivity heat-absorbing materials used in the present disclosure are as follows:

1. The preparation method for the flame-retardant graphite-loaded organic tin catalyst C-1 includes the following steps:

adding 50 g of flame-retardant graphite and 55 g of dibutyl tin diacetate into a reactor, adding 50 g of cyclohexane, maintaining the temperature at 50 DEG C., performing stirring for 2 h, placing same in a constant-temperature drying box at the temperature of 90 DEG C. for drying for 24 h, and obtaining the catalyst C-1.

2. The preparation method for the high-heat-conductivity heat-absorbing material G-1 includes the following steps:
S1: adding 80 g of LPA-1 bonding glue, 5 g of the flame-retardant graphite-loaded organic tin catalyst C-1 and 50 g of carbon nanotubes into a mixing kettle, heating same to 40-50 DEG C., and stirring same for 2.5 h;
S2: slowly adding the heat-absorbing materials, including 300 g of potassium aluminum sulfate dodecahydrate and 565 g of calcium chloride hexahydrate, into the mixing kettle, performing stirring while adding, performing vacuumizing to remove bubbles, and obtaining mixed glue;
S3: pouring the mixed glue into a polytetrafluoroethylene mold with a specified length of 30 cm, a specified width of 30 cm and a specified thickness of 2 mm, and curing same at a room temperature for 5-8 h; and
S4: performing demolding after curing time, and obtaining the high-heat-conductivity heat-absorbing material G-1, where the heat absorption enthalpy at the temperature of 50-300 DEG C. is tested to be 1330 J/g.

In the steps, the high-heat-conductivity heat-absorbing material includes the following raw materials in percentage by mass: 86.5% of the heat-absorbing materials, 5% of the heat-conducting material carbon nanotubes, 0.5% of the flame-retardant graphite-loaded organic tin catalyst and 8% of the bonding glue.

3. The preparation method for the high-heat-conductivity heat-absorbing material G-2 includes the following steps:
S1: adding 70 g of the LPA-1 bonding glue, 2 g of the flame-retardant graphite-loaded organic tin catalyst C-1 and 30 g of flame-retardant graphite into a mixing kettle, heating same to 30-40 DEG C., and stirring same for 3.5 h;
S2: slowly adding the heat-absorbing materials, including 300 g of silicic acid and 598 g of calcium chloride hexahydrate, into the mixing kettle, performing stirring while adding, performing vacuumizing to remove bubbles, and obtaining mixed glue;
S3: pouring the mixed glue into a polytetrafluoroethylene mold with a specified length of 30 cm, a specified width of 30 cm and a specified thickness of 2 mm, and curing same at a room temperature for 12-24 h; and
S4: performing demolding after curing time, and obtaining the high-heat-conductivity heat-absorbing material G-2, where the heat absorption enthalpy at the temperature of 50-300 DEG C. is tested to be 1440 J/g.

In the steps, the high-heat-conductivity heat-absorbing material includes the following raw materials in percentage by mass: 89.8% of the heat-absorbing materials, 3% of the heat-conducting material flame-retardant graphite, 0.2% of the flame-retardant graphite-loaded organic tin catalyst and 7% of the bonding glue.

4. The preparation method for the high-heat-conductivity heat-absorbing material G-3 includes the following steps:
S1: adding 95 g of LPA-1 bonding glue, 30 g of graphene and 10 g of carbon nanotubes into a mixing kettle, heating same to 45-55 DEG C., and stirring same for 4 h;
S2: slowly adding the heat-absorbing materials, including 665 g of sodium acetate trihydrate and 200 g of potassium aluminum sulfate dodecahydrate, into the mixing kettle, performing stirring while adding, performing vacuumizing to remove bubbles, and obtaining mixed glue;
S3: pouring the mixed glue into a polytetrafluoroethylene mold with a specified length of 30 cm, a specified width of 30 cm and a specified thickness of 2 mm, and curing same at a room temperature for 24-48 h; and
S4: performing demolding after curing time, and obtaining the high-heat-conductivity heat-absorbing material G-3, where the heat absorption enthalpy at the temperature of 50-300 DEG C. is tested to be 1226 J/g.

In the steps, the high-heat-conductivity heat-absorbing material includes the following raw materials in percentage by mass: 86.5% of the heat-absorbing materials, 4% of the heat-conducting materials (graphene and carbon nanotubes) and 9.5% of the bonding glue.

### Embodiment 1

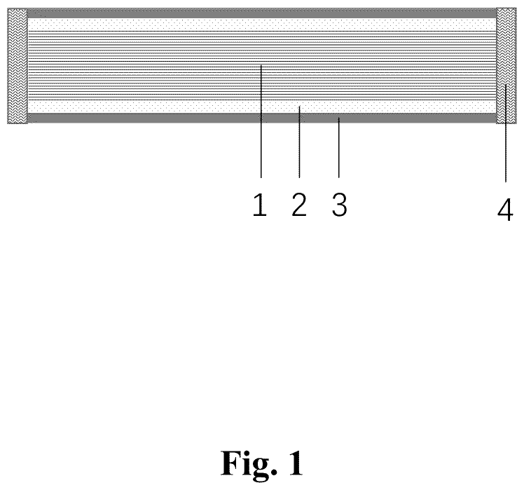

A thermal runaway protection material capable of rapidly absorbing heat, as shown in FIG. 1, is of a laminated structure and sequentially includes a 0.2-mm flame-retardant graphite heat-conducting film, 0.21-mm SE4450 heat-conducting glue, a 2-mm high-heat-conductivity heat-absorbing material G-1, 0.21-mm SE4450 heat-conducting glue and a 0.2-mm flame-retardant graphite heat-conducting film from bottom to top.

A preparation method for the thermal runaway protection material capable of rapidly absorbing heat includes the following steps: brushing an upper surface and a lower surface of the high-heat-conductivity heat-absorbing material G-1 with the SE4450 heat-conducting glue, then covering surfaces of the SE4450 heat-conducting glue with the flame-retardant graphite heat-conducting films, performing flattening by means of a mold, cutting same into a sheet with a specified length of 23 cm and a specified width of 16 cm after placing at the room temperature for 24 h, then brushing side surfaces with the edge sealing glue, and obtaining the thermal runaway protection material A after placing at the room temperature for 1 h, where the average value of the thickness is 2.82 mm, and the heat conductivity coefficient and the enthalpy value and density of the internal high-heat-conductivity heat-absorbing material are as shown in Table 2.

### Embodiment 2

A thermal runaway protection material capable of rapidly absorbing heat is of a laminated structure and sequentially includes a 0.2-mm flame-retardant graphite heat-conducting film, 0.115-mm SE4450 heat-conducting glue, a 2-mm high-heat-conductivity heat-absorbing material G-1, 0.115-mm SE4450 heat-conducting glue and a 0.2-mm flame-retardant graphite heat-conducting film from bottom to top.

A preparation method for the thermal runaway protection material capable of rapidly absorbing heat includes the following steps: brushing an upper surface and a lower surface of the high-heat-conductivity heat-absorbing material G-2 with the SE4450 heat-conducting glue, then covering surfaces of the SE4450 heat-conducting glue with the flame-retardant graphite heat-conducting films, performing flattening by means of a mold, cutting same into a sheet with a specified length of 23 cm and a specified width of 16 cm after placing at the room temperature for 24 h, then brushing side surfaces with the edge sealing glue, and obtaining the thermal runaway protection material B after placing at the room temperature for 1 h, where the average value of the thickness is 2.63 mm, and the heat conductivity coefficient and the enthalpy value and density of the internal high-heat-conductivity heat-absorbing material are as shown in Table 2.

### Embodiment 3

A thermal runaway protection material capable of rapidly absorbing heat is of a laminated structure and sequentially includes a 0.2-mm flame-retardant graphite heat-conducting film, 0.17-mm SE4450 heat-conducting glue, a 2-mm high-heat-conductivity heat-absorbing material G-1, 0.17-mm SE4450 heat-conducting glue and a 0.2-mm flame-retardant graphite heat-conducting film from bottom to top.

A preparation method for the thermal runaway protection material capable of rapidly absorbing heat includes the following steps: brushing an upper surface and a lower surface of the high-heat-conductivity heat-absorbing material G-3 with the SE4450 heat-conducting glue, then covering surfaces of the SE4450 heat-conducting glue with the flame-retardant graphite heat-conducting films, performing flattening by means of a mold, cutting same into a sheet with a specified length of 23 cm and a specified width of 16 cm after placing at the room temperature for 24 h, then brushing side surfaces with the edge sealing glue, and obtaining the thermal runaway protection material C after placing at the room temperature for 1 h, where the average value of the thickness is 2.74 mm, and the heat conductivity coefficient and the enthalpy value and density of the internal high-heat-conductivity heat-absorbing material are as shown in Table 2.

### Property Characterization

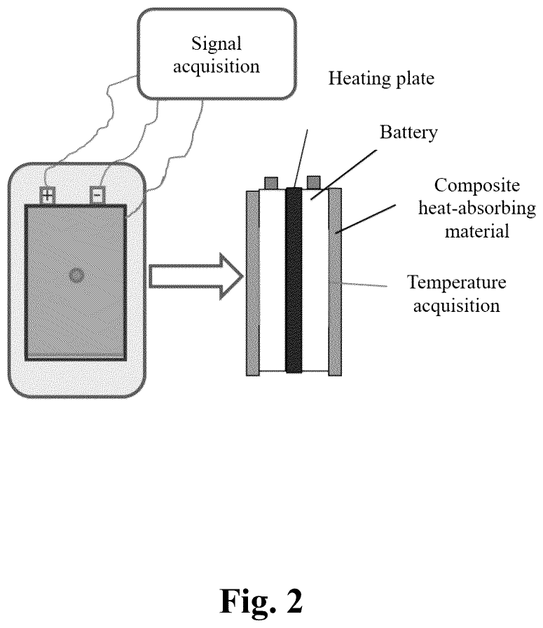

A test platform is built to test the thermal runaway effect of the thermal runaway protection material capable of rapidly absorbing heat in the present disclosure. A heating plate with the power being 500 W is sandwiched between the centers of two soft-pack lithium iron phosphate batteries with the external dimensions being 227*160*7.25 mm, the standard voltage being 3.3 V and the full-charged capacity being 20 AH, and a signal acquisition device is connected to the two batteries to acquire voltages and surface temperatures of the two batteries. Then the three kinds of thermal runaway protection materials prepared in the embodiments and having the sizes being 230*160 mm are respectively attached to two outer surfaces of the batteries, and a blank sample without the thermal runaway protection materials is manufactured. The structure is as shown in FIG. 2.

The test steps are as follows: electrifying the heating plate for heating, setting the temperature power of the heating plate to be 100%, acquiring the voltages and temperatures of the batteries, stopping heating when the acquired voltages of the batteries become 0 V, continuously acquiring the temperatures of the batteries until the temperatures of the batteries drop below 50 DEG C., and stopping data acquisition. Results are as shown in Table 3.

TABLE 2
Property Tests of Embodiments

| | | | Enthalpy value | | |
|---|---|---|---|---|---|
| | No. of | | of internal | | |
| | thermal | Heat | high-heat- | | |
| | runaway | conductivity | conductivity | | |
| | protection | coefficient | heat-absorbing | | Average |
| S/N | material | (1) | material (2) | Density (3) | thickness |
| 1 | A | 1.12 W/m · K | 1330 J/g | 1.56 g/cm³ | 2.82 mm |
| 2 | B | 1.25 W/m · K | 1440 J/g | 1.73 g/cm³ | 2.63 mm |
| 3 | C | 1.19 W/m · K | 1226 J/g | 1.48 g/cm³ | 2.74 mm |

Note:
(1) The heat conductivity coefficient refers to an ISO 22007-2test
(2) Differential scanning calorimetry test
(3) Density = weight/volume

TABLE 3
Application Tests of Embodiments

| | No. of thermal | | |
|---|---|---|---|
| | runaway | | Maximum |
| | protection | Time when | temperature of |
| S/N | material | voltage is 0 | battery (1) |
| Embodiment 1 | A | 685 s | 138° C. |
| Embodiment 2 | B | 720 s | 143° C. |
| Embodiment 3 | C | 643 s | 160° C. |
| Comparison | Blank | 360 s | 262° C. |
| embodiment 1 | | | |
| Comparison | Aerogel pad | 320 s | 310° C. |
| embodiment 2 | 2.5 mm | | |

Note:
this temperature is the temperature of the battery with the highest temperature in the entire test process.

It can be seen from the tests that the blank sample (comparison embodiment 1) does not use the thermal runaway protection material, complete thermal runaway occurs when the heating plate performs heating for 360 s, and the maximum temperature of the battery reaches 262° C. For a sample (comparison embodiment 2) using aerogel, due to the thermal insulation effect of the aerogel, the temperature inside the battery rises more rapidly, complete thermal runaway occurs after 320 s, and the maximum temperature also reaches 310° C. However, the sample using the thermal runaway protection material A/B/C in the present disclosure endures almost twice the heating time than the blank sample, and the maximum temperatures of the battery are respectively 138° C., 143° C. and 160° C. in the entire test process and are more than 100° C. lower than the temperature of the blank sample. This fully indicates that the thermal runaway protection material in the present disclosure has an obvious effect on thermal runaway control.

The above are only specific application examples of the present disclosure, and do not limit the scope of protection of the present disclosure. In addition to the above embodiments, the present disclosure may also have other implementation manners. Any technical solution formed by equivalent substitutions or equivalent transformations should fall within the scope of protection of the present disclosure.

1. A thermal runaway protection material capable of rapidly absorbing heat, which is of a laminated structure and sequentially comprises a flame-retardant graphite heat-conducting film, heat-conducting glue, a high-heat-conductivity heat-absorbing material, heat-conducting glue and a flame-retardant graphite heat-conducting film from bottom to top, wherein the high-heat-conductivity heat-absorbing material comprises the following components in percentage by mass: 80-94% of a heat-absorbing material, 1-10% of a heat-conducting material, 0-1% of a flame-retardant graphite-loaded organic tin catalyst and 5-10% of bonding glue; the heat absorption enthalpy of the heat-absorbing material is greater than 1200 J/g, the heat-absorbing material is a material that is subjected to a chemical reaction at the temperature of 60-400 DEG C. and actively absorbs heat, heat absorption by means of the reaction is carried out spontaneously after conditions of the chemical reaction are reached, and the effect of continuous heat absorption is formed; and the heat-conducting material is a carbon-based heat-conducting material.

2. The thermal runaway protection material capable of rapidly absorbing heat according to claim 1, wherein the thickness of the heat-conducting glue is in a range of 0.02-0.25 mm; and the thickness of the flame-retardant graphite heat-conducting films is in a range of 0.02-0.5 mm.

3. The thermal runaway protection material capable of rapidly absorbing heat according to claim 1, wherein peripheral side surfaces of the laminated structure are packaged by means of edge sealing glue; and the thermal runaway protection material is a block or a sheet.

4. The thermal runaway protection material capable of rapidly absorbing heat according to claim 1, wherein the thickness of the high-heat-conductivity heat-absorbing material is in a range of 0.5-100 mm.

5. The thermal runaway protection material capable of rapidly absorbing heat according to claim 1, wherein a preparation method for the high-heat-conductivity heat-absorbing material comprises the following steps:
S1: adding the bonding glue, the flame-retardant graphite-loaded organic tin catalyst and the carbon-based heat-conducting material into a mixing kettle, heating same to 30-60 DEG C., and stirring same for 2-4 h;
S2: slowly adding the heat-absorbing material into the mixing kettle, performing stirring while adding, performing vacuumizing to remove bubbles, and obtaining mixed glue; and
S3: pouring the mixed glue into a mold in a specified shape and thickness, curing same at a room temperature for 0.5-48 h, and performing demolding to obtain the high-heat-conductivity heat-absorbing material; and
in the steps, the high-heat-conductivity heat-absorbing material comprises the following raw materials in percentage by mass: 80-94% of the heat-absorbing material, 1-10% of the heat-conducting material, 0-1% of the flame-retardant graphite-loaded organic tin catalyst and 5-10% of the bonding glue.

6. The thermal runaway protection material capable of rapidly absorbing heat according to claim 1, wherein the heat-absorbing material comprises but is not limited to one of or a mixture of a plurality of the following components in any ratio: sodium acetate trihydrate, ammonium iron oxalate trihydrate, citric acid monohydrate, citric acid, oxalic acid dihydrate, anhydrous oxalic acid, barium hydroxide octahydrate, malonic acid, magnesium sulfate heptahydrate, zinc sulfate heptahydrate, succinic acid, maleic acid, fumaric acid, sodium carbonate decahydrate, calcium chloride hexahydrate, aluminum nitrate nonahydrate, boric acid, ammonium pentaborate octahydrate, ammonium iron sulfate dodecahydrate, ferrous chloride tetrahydrate, ammonium oxalate monohydrate, sodium tetraborate decahydrate, sodium tetraborate pentahydrate, aluminum sulfate octadecahydrate, ammonium pentaborate, ammonium tetraborate tetrahydrate, sodium silicate pentahydrate, sodium aluminosilicate hydrate, potassium aluminum sulfate dodecahydrate, sodium sulfate decahydrate, copper sulfate heptahydrate, ferrous sulfate heptahydrate, cobalt chloride hexahydrate and calcium sulfate dihydrate;
the carbon-based heat-conducting material is one of or a mixture of the following components in any ratio: carbon nano tubes, expanded graphite, flame-retardant graphite and graphene; and
the flame-retardant graphite-loaded organic tin catalyst comprises flame-retardant graphite and dibutyl tin diacetate in a mass ratio of 1:1 to 2:1.

7. The thermal runaway protection material capable of rapidly absorbing heat according to claim 1, wherein a preparation method for the flame-retardant graphite-loaded organic tin catalyst comprises the following steps: adding flame-retardant graphite and dibutyl tin diacetate in a mass ratio of 1:1 to 2:1 into a reactor, then adding cyclohexane accounting for 30-100% of the total mass of flame-retardant graphite and dibutyl tin diacetate, maintaining the temperature at 40-60 DEG C., performing stirring for 2-3 h, and obtaining the flame-retardant graphite-loaded organic tin catalyst after drying.

8. The thermal runaway protection material capable of rapidly absorbing heat according to claim 1 or 2, wherein each of the flame-retardant graphite heat-conducting films is a heat-conducting film prepared by compounding flame-retardant graphite with plastic particles, has a heat conductivity coefficient greater than 1 W/m·K, is in a flame-retardant level of UL94-V0, and has the thickness in a range of 0.02-0.5 mm; and the heat-conducting glue has a heat conductivity coefficient greater than 1 W/m·K and the thickness in a range of 0.02-0.2 mm.

9. A preparation method for the thermal runaway protection material capable of rapidly absorbing heat according to claim 1, wherein the preparation method comprises the following steps: respectively brushing an upper surface and a lower surface of the high-heat-conductivity heat-absorbing material with heat-conducting glue layers, then covering surfaces of the heat-conducting glue with the flame-retardant graphite heat-conducting films, performing flattening by means of a mold, after curing at a room temperature, cutting the high-heat-conductivity heat-absorbing material into a specified size, then brushing side surfaces with edge sealing glue, and obtaining the thermal runaway protection material after drying.

10. A packaging method for achieving high heat conductivity and modularization of a heat-absorbing material, comprising the following steps:
S1: adding bonding glue, a flame-retardant graphite-loaded organic tin catalyst and a carbon-based heat-conducting material into a mixing kettle, heating same to 30-60 DEG C., and stirring same for 2-4 h;
S2: slowly adding a heat-absorbing material into the mixing kettle, performing stirring while adding, performing vacuumizing to remove bubbles, and obtaining mixed glue, wherein the heat absorption enthalpy of the heat-absorbing material is greater than 1200 J/g, the heat-absorbing material is a material that is subjected to a chemical reaction at the temperature of 60-400 DEG C. and actively absorbs heat, heat absorption by means of the reaction is carried out spontaneously after conditions of the chemical reaction are reached, and the effect of continuous heat absorption is achieved;
S3: pouring the mixed glue into a mold in the specified shape and thickness, and after curing at a room temperature, performing demolding to obtain the high-heat-conductivity heat-absorbing material, wherein the high-heat-conductivity heat-absorbing material comprises the following components in percentage by mass: 80-94% of the heat-absorbing material, 1-10% of the heat-conducting material, 0-1% of the flame-retardant graphite-loaded organic tin catalyst and 5-10% of the bonding glue;
S4: respectively brushing an upper surface and a lower surface of the high-heat-conductivity heat-absorbing material with heat-conducting glue layers, then covering surfaces of the upper and lower layers of heat-conducting glue with flame-retardant graphite heat-conducting films, performing flattening by means of a mold, after curing at the room temperature, cutting the high-heat-conductivity heat-absorbing material into a specified size, and obtaining a laminated structure sequentially comprising the flame-retardant graphite heat-conducting film, the heat-conducting glue, the high-heat-conductivity heat-absorbing material, the heat-conducting glue and the flame-retardant graphite heat-conducting film from bottom to top;
S5: brushing side surfaces of the laminated structure with edge sealing glue, and obtaining a packaged thermal runaway protection material block or sheet after drying; and
S6: preparing the packaged thermal runaway protection material block or sheet into a required size, and directly mounting same on a heating part in an attached manner, thereby achieving modular packaging of the high-heat-conductivity heat-absorbing material around the heating part.

11. The thermal runaway protection material capable of rapidly absorbing heat according to claim 2, wherein peripheral side surfaces of the laminated structure are packaged by means of edge sealing glue; and the thermal runaway protection material is a block or a sheet.

12. The thermal runaway protection material capable of rapidly absorbing heat according to claim 5, wherein the heat-absorbing material comprises but is not limited to one of or a mixture of a plurality of the following components in any ratio: sodium acetate trihydrate, ammonium iron oxalate trihydrate, citric acid monohydrate, citric acid, oxalic acid dihydrate, anhydrous oxalic acid, barium hydroxide octahydrate, malonic acid, magnesium sulfate heptahydrate, zinc sulfate heptahydrate, succinic acid, maleic acid, fumaric acid, sodium carbonate decahydrate, calcium chloride hexahydrate, aluminum nitrate nonahydrate, boric acid, ammonium pentaborate octahydrate, ammonium iron sulfate dodecahydrate, ferrous chloride tetrahydrate, ammonium oxalate monohydrate, sodium tetraborate decahydrate, sodium tetraborate pentahydrate, aluminum sulfate octadecahydrate, ammonium pentaborate, ammonium tetraborate tetrahydrate, sodium silicate pentahydrate, sodium aluminosilicate hydrate, potassium aluminum sulfate dodecahydrate, sodium sulfate decahydrate, copper sulfate heptahydrate, ferrous sulfate heptahydrate, cobalt chloride hexahydrate and calcium sulfate dihydrate;
the carbon-based heat-conducting material is one of or a mixture of the following components in any ratio: carbon nano tubes, expanded graphite, flame-retardant graphite and graphene; and
the flame-retardant graphite-loaded organic tin catalyst comprises flame-retardant graphite and dibutyl tin diacetate in a mass ratio of 1:1 to 2:1.

13. The thermal runaway protection material capable of rapidly absorbing heat according to claim 5, wherein a preparation method for the flame-retardant graphite-loaded organic tin catalyst comprises the following steps: adding flame-retardant graphite and dibutyl tin diacetate in a mass ratio of 1:1 to 2:1 into a reactor, then adding cyclohexane accounting for 30-100% of the total mass of flame-retardant graphite and dibutyl tin diacetate, maintaining the temperature at 40-60 DEG C., performing stirring for 2-3 h, and obtaining the flame-retardant graphite-loaded organic tin catalyst after drying.

14. The thermal runaway protection material capable of rapidly absorbing heat according to claim 2, wherein each of the flame-retardant graphite heat-conducting films is a heat-conducting film prepared by compounding flame-retardant graphite with plastic particles, has a heat conductivity coefficient greater than 1 W/m·K, is in a flame-retardant level of UL94-V0, and has the thickness in a range of 0.02-0.5 mm; and the heat-conducting glue has a heat conductivity coefficient greater than 1 W/m·K and the thickness in a range of 0.02-0.2 mm.

15. A preparation method for the thermal runaway protection material capable of rapidly absorbing heat according to claim 2, wherein the preparation method comprises the following steps: respectively brushing an upper surface and a lower surface of the high-heat-conductivity heat-absorbing material with heat-conducting glue layers, then covering surfaces of the heat-conducting glue with the flame-retardant graphite heat-conducting films, performing flattening by means of a mold, after curing at a room temperature, cutting the high-heat-conductivity heat-absorbing material into a specified size, then brushing side surfaces with edge sealing glue, and obtaining the thermal runaway protection material after drying.
